(19) United States
(12) Patent Application Publication
(10) Pub. No.: US 2025/0238749 A1
(43) Pub. Date: Jul. 24, 2025

(54) METHODS AND SYSTEMS FOR ANALYZING AGENT PERFORMANCE

(71) Applicant: TPG Telemanagement, Inc., Omaha, NE (US)

(72) Inventors: Lisa DeFalco, Bradenton, FL (US); Michael Tommy Shrove, Madison, AL (US); Timothy Sobey, Yardley, PA (US); Christopher Ely, Yardley, PA (US)

(73) Assignee: TPG Telemanagement, Inc., Omaha, NE (US)

(21) Appl. No.: 19/177,126

(22) Filed: Apr. 11, 2025

Related U.S. Application Data
(63) Continuation of application No. 17/943,083, filed on Sep. 12, 2022, now abandoned.
(60) Provisional application No. 63/289,996, filed on Dec. 15, 2021.

(51) Int. Cl. G06Q 10/0639; G10L 15/16; G10L 15/26; H04M 3/51

(52) U.S. Cl. CPC G06Q 10/06398; G10L 15/16; G10L 15/26; H04M 3/5175; H04M 2203/401

(57) ABSTRACT

The present disclosure generally relates to methods, systems, apparatuses, and non-transitory computer readable media for customer service agent performance analysis These systems may be of use across a wide-range of applications involving interactions between an organization's representative and one of the organization's customers, users, or similarly situated individual. By enabling a representative's performance to be autonomously assessed, a vastly greater percentage of a business's customer service interactions may be assessed than can be done using traditional human-based evaluations. In turn, the increased assessments may allow an organization to better target training and promotion opportunities and improve the effectiveness of its customer interactions.

### CROSS-REFERENCE TO RELATED APPLIACTION

This application is a continuation of U.S. patent application Ser. No. 17/943,083, filed Sep. 12, 2022, which is incorporated by reference in its entirety. U.S. patent application Ser. No. 17/943,083 claims priority to U.S. Provisional Patent Application No. 63/289,996, filed on Dec. 15, 2021, which is incorporated herein by reference in its entirety.

### TECHNICAL FIELD

The present disclosure generally relates to agent behavior analysis, and more particularly, methods, systems, apparatuses, and non-transitory computer readable media for customer service agent performance analysis.

### BACKGROUND

Contact centers—a more modern term for call centers that include other forms of communication—are an important touchpoint for many companies to interact with their customers. Today, contact centers are most commonly used to provide various forms of customer support, such as providing technical assistance with using a product (i.e., technical support). Contact centers are frequently used to provide customer service because they allow real-time interaction between a company's customer and the company's representative (here, an agent at the contact center). In real-time, the agent can organically tailor the interaction to the customer's specific needs, such as by asking clarifying questions. This often results in faster and more effective assistance to a customer compared to delayed interactions, such as interactions via email.

The real-time nature of contact centers also provides an opportunity for businesses to foster long-term relationships with its customers by making a positive impressions on them during the course of their interaction with the contact center agent. Unfortunately, this same potential for an organically tailored experience also creates the possibility of harming a business's relationship with its customers by leaving a negative impression during the interaction.

The ways in which an agent can leave a negative impression with a customer are—like most human interaction—innumerable. For example, the agent may say something that comes across as rude or unfriendly or does not otherwise meet the customer's expectations. While contact center agents are typically guided by a script or flowchart to avoid certain problems, the human nature of the participants means that customers can respond both positively and negatively to the language and attitude exhibited by the agent, and agents can, despite training, still convey attitudes and emotions with their language that can affect a customer negatively, adversely affecting the customer's attitude and behavior towards the company.

Managing contact center agents to ensure their interactions with customers are positive is thus a key consideration for companies in maintaining positive consumer perception. In turn, this requires analysis of contact center agent's interactions with customers to evaluate their performance. Currently, this evaluation is often performed manually by supervisors, which listen to many calls and perform subjective evaluation of agents. This process is time-consuming, inefficient, and highly subjective, leading to a difficulty in assessing agents across an enterprise. Further, given limited resources, manual evaluation of a large number of interactions is often not feasible, and a large number of interactions may simply go unevaluated. Further, even for interactions evaluated by a human operated, human error in evaluating the interactions can adversely affect the robustness of the evaluation process.

Thus, there is an ever-growing need to evaluate agents, or perform some portion of the process of evaluating agents, without requiring the substantial involvement of a human evaluator. Indeed, attempts have been made to attempt automation of the process of evaluating agent performance in customer calls, but accurately and thoroughly assessing agent performance in an automated fashion without subjective input by a human operator listening to the calls is difficult, and automated solutions to date have had only limited effectiveness. Indeed, many defects in agent behavior are missed or simply incapable of evaluation by conventional systems.

Thus, methods capable of autonomously and robustly performing the task of evaluating agent performance, or some subset of it, with improved effectiveness are greatly desired.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a block diagram of an interaction analytics engine, according to an exemplary embodiment of the present disclosure.

FIG. 2 is a flowchart illustrating an exemplary method of using an interaction analytics engine to process digital recordings, according to an exemplary embodiment of the present disclosure.

FIG. 3 is a block diagram of an interaction analytics system implementing an interaction analytics engine, according to an exemplary embodiment of the present disclosure.

FIG. 4 is a more detailed block diagram of a media engine, according to an exemplary embodiment of the present disclosure.

FIG. 5 is a more detailed block diagram of a transcript annotation engine, according to an exemplary embodiment of the present disclosure.

FIG. 6 is a more detailed block diagram of a transcript evaluation engine, according to an exemplary embodiment of the present disclosure.

FIG. 7 is a diagram of a timeline that may be displayed during a playback of a digital recording including markers that indicative of defects detected by an interaction analytics engine.

FIG. 8A is a diagram of a compendium, according to an exemplary embodiment of the present disclosure.

FIG. 8B is a diagram of a scored compendium, according to an exemplary embodiment of the present disclosure.

### DETAILED DESCRIPTION

Reference will now be made in detail to exemplary embodiments, examples of which are

illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The present disclosure generally pertains to systems and methods for autonomously evaluating agent performance. These systems may be of use across a wide-range of applications involving interactions between an organization's representative and one of the organization's customers, users, or similarly situated individual. By enabling a representative's performance to be autonomously assessed, a vastly greater percentage of a business's customer service interactions may be assessed than can be done using traditional human-based evaluations. In turn, the increased assessments may allow an organization to better target training and promotion opportunities and improve the effectiveness of its customer interactions. In addition, using the techniques described herein, the effectiveness of the system in autonomously evaluating customer interactions can be improved relative to conventional approaches.

At a high level, embodiments of the present disclosure may enable accurately and autonomously reviewing an interaction between two or more individuals to generate an assessment about that interaction. In general, this assessment may include data covering a wide range of topics about the interaction, including both the nature of the interaction (such as its purpose) and the behavior of the individuals (such as their tone and expressed sentiment). Additionally, the data included in the assessment may be at a variety of levels, in the sense that some assessment data is determined directly from the interaction while other assessment data is determined, at least partially, from other, already determined assessment data.

For example, assessments may include lower-level data in the form of information about the raw representation of the interaction—such as periods of sustained silence—or information that may be immediately determined from the raw representation—e.g., what was said (in text format) during the interaction. In addition, assessments may include higher-level data in the form of inferences about the communication that occurred during the interaction, including lower-order inferences like what sentiment was conveyed by a person at a particular point in the interaction and higher order inferences like what was the overall purpose of the interaction.

One especially notable category of higher-order inferences are assessments about the performance of a contact center agent in interacting with a customer, particularly with regards to maintaining a good relationship with the customer (i.e., customer satisfaction). For many organizations, maintaining a minimum standard of quality in a customer's experience interacting with the contact center agents is an important part of the organization's strategy for customer retention and, consequently, the organization's overall success.

In turn, the way many organizations seek to maintain the quality of customer's interactions with its contact centers is to periodically assess its agents' performance to detect any deficiencies or problems in how an agent interacts with customers. If a problem is found in the agent's performance, the organization can then take remedial action to address it, such as by providing feedback on and training to correct identified deficiencies in an agent's interaction with customers.

Generally, evaluations can be performed manually by a human supervisor, who reviews an interaction, such as by listening to a voice call, reading a transcript of a text chat, or reading an email conversation thread, and then completes an evaluation form for the agent based on the review. The evaluation form may have entries for assessments on a variety of specific aspects of the agent's behavior during the interaction, each of which may be scored (e.g., meets expectations and does not meet expectations). For example, the agent's performance is often evaluated with respect to behavior, such as whether the agent was polite and courteous, and with respect to effectiveness, such as whether the agent was able to resolve the customer's issue and whether the agent was time efficient in doing so.

Unfortunately, the process of a supervisor (or any human reviewer) manually evaluating an agent's performance is often time-consuming and cumbersome to perform. Because of the expense and difficulty of traditional human-based review, most companies will evaluate only a small fraction of each of their agent's interactions, leaving the vast majority of the agent interactions unevaluated. In some systems, interactions may be randomly selected (or sampled) for evaluation. However, most such sampled interactions will be “uninteresting” in that they merely demonstrate agent competence in meeting performance standards. On the other hand, uncommon “interesting” interactions such as those containing instances of unusually good behavior or containing violations of company policy may go undetected if those interactions are not selected for human supervisor evaluation. Thus, this sampling approach has a significant probability of missing uncommon but important aspects of the agent's performance.

To address these issues, embodiments of the present disclosure may employ a process to autonomously evaluate interactions between an agent and one or more customers, including, among other aspects, an assessment of the agent's performance during the interactions. This can greatly reduce the cost and burden of evaluating an agent's performance. Moreover, this autonomous evaluation can also improve the reliability of the assessment of an agent's overall performance by making it practical for all or at least a significant portion of an agent's interactions to be assessed.

A process used by embodiments of the present disclosure to autonomously evaluate an interaction may be (logically) divided into multiple stages. First, data corresponding to a digital recording of the interaction—such as an MP3 audio file or an AVI video file—may be obtained and pre-processed into a standard format. Then, the standardized digital recording data may be analyzed to generate an annotated transcript of the interaction by first extracting a basic transcript of the discourse between the agent and customer and then interweaving annotations into the basic transcript that detail useful features (e.g., information) inferred from the text and raw audiovisual components of the digital recording.

After it is generated, the feature-annotated transcript may be analyzed to determine the correct responses to pre-defined questions or aspects of the interaction, each of which is called an “attribute.” In general, attributes, which may be grouped by category into one or more compendiums, are about aspects of the interaction that are of human interest in understanding the recorded interaction and evaluating the agent's performance. The answers to the attributes relevant to the evaluated interaction, which are individually referred to as “scores” and which collectively comprise a “scored compendium,” ideally constitute a near comprehensive overview of the context of the interaction and the agent's performance during the interaction. Where useful to distinguish it from a scored compendium, a compendium considered as a group of (unanswered) attributes may be called a “template compendium.”

Ultimately, this scored compendium may be used for a variety of purposes. For example, as is described in more detail below, multiple scored compendiums for an agent—such as scored compendiums for all of their client interactions within the last year—may be aggregated to detect trends in the agent's performance and to guide training/coaching of the agent or make other decisions, such as evaluating the agent for promotions or continued employment.

Note that, for clarity and readability, the recorded interaction is discussed as being between a single agent and a single customer. However, embodiments of the present disclosure may be equally applied to recorded interactions where multiple “customers” speak or where “multiple” agents speak.

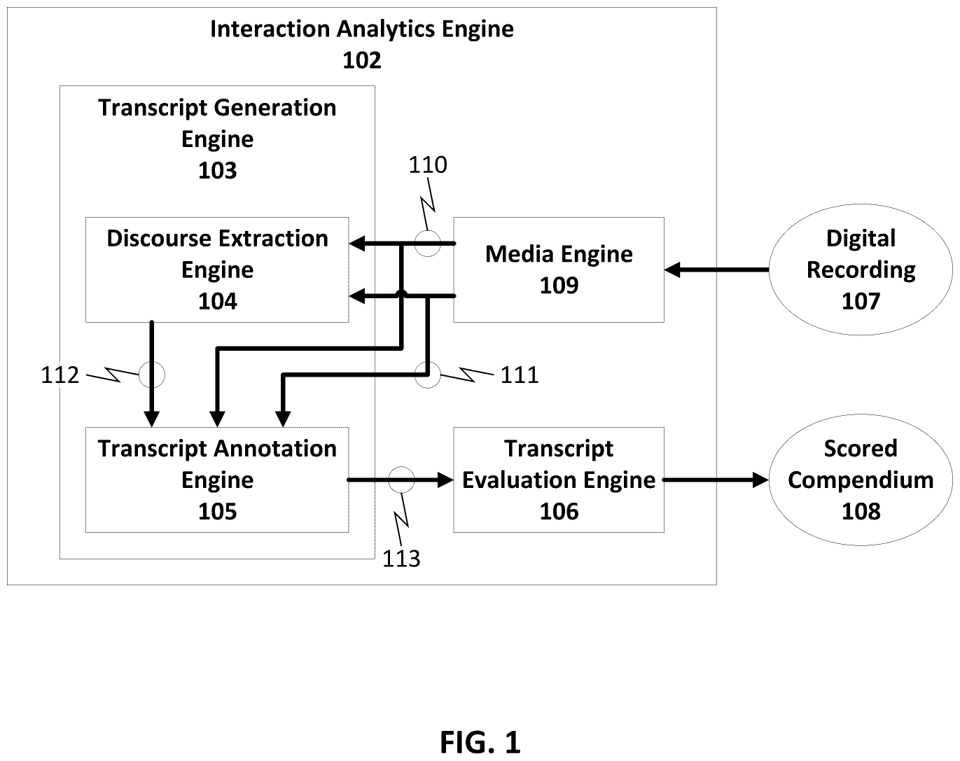

FIG. 1 is a diagram illustrating a logical architecture for autonomously evaluating one or more interactions, as was just described. As shown by the figure, an interaction analytics engine (IAE) 102 may comprise a media engine 109, a transcript generation engine (TGE) 103, and a transcript evaluation engine (TEE) 106. In turn, the transcript generation engine 103 may comprise a discourse extraction engine 104 and a transcript annotation engine 105. Also shown is a digital recording 107, which may be the input to the IAE 102 (e.g., a media file of an interaction), and a scored compendium 108, which may be the output of the IAE 102 (e.g., an assessment of the interaction in the form of scores for various attributes). As indicated by the arrows, the components of the AIE 102 broadly form a data pipeline, with information flowing from the media engine 109 to the TGE 103 and from the TGE 103 to the TEE 106.

Like the process described above, the high-level purpose of the IAE 102 is to generate, from a digital recording and without needing outside human assistance, a useful assessment of an interaction between an agent and a customer. To achieve this goal, the media engine 109, transcript generation 103, and the transcript evaluation engine 106 may work together to perform the tasks of the previously discussed logic stages in the process of autonomously evaluating a digital recording. Specifically, the AIE 102 may first receive the digital recording 107 and process it using the media engine 109. Among other tasks, the media engine 109 may convert the digital recording 107 into a standardized form—referred to as standardized digital recording 110—for use by later components of the AIE 102. The media engine 109 may also extract certain file level metadata-referred to as extracted recording metadata 111—from the digital recording 107. The standardized digital recording 110 and extracted recording metadata 111 may then be passed to the transcript generation engine 103.

After the TGE 103 standardized digital recording 110 and extracted recording metadata 111, it may analyze and process them using the discourse extraction engine 104. At a high-level, the purpose of the TGE 103 is to create an “enhanced” transcript of the discourse between the agent and customer (as captured by the standardized digital recording 110). This “enhanced” transcript—referred to as a feature-annotated discourse transcript—may be conceptualized as a “basic” discourse transcript—referred to as an initial discourse transcript—interwoven with various annotations. These annotations, which may be any of a variety of data, broadly indicate features (i.e., information) determinable from the standardized digital recording 110 that have been found to be useful in scoring the various attributes of the compendiums with which the IAE 102 is evaluating the interaction. By preemptively extracting these features and then using them to score various attributes, as opposed to directly using the standardized digital recording 107, the speed and efficiency of the evaluation process are increased, and the resource requirements are reduced. Further, use of the extracted features also helps to enhance the accuracy and effectiveness of the evaluation process.

More precisely, the TGE 103 may first process the standardized digital recording 110 and extracted recording metadata 111 received from the media engine 109 to generate the initial discourse transcript in the form of initial discourse transcript data 112. The initial discourse transcript data 112 may comprise text transcriptions of the discourse along with timestamps indicating when each word or utterance (e.g., vocables such as “uh-huh,” “hmm,” “uh,” etc.) was made. Next, the initial discourse transcript data 112 may be passed to the transcript annotation engine 105, which may also receive the standardized digital recording 110 and extracted recording metadata 111 from the media engine 109.

As discussed in more detail below, the transcript annotation engine 105 may analyze the standardized digital recording 110, the extracted recording metadata 111, and the initial discourse transcript data 112, either separately or jointly, to determine and extract information about the interaction between the agent and customer. These features-which may apply to the transcript at any level of granularity, from individual utterances to the entire transcript—are higher order information about the specific discourse to which they apply that are useful in assessing desired attributes about the interaction. Ideally, these features capture much of the information contained in the raw audiovisual components of the standardized digital recording 110. Moreover, the contents of the feature-annotated discourse transcript alone may be sufficient for effective operation of the second step.

After the TGE 103 generates the feature-annotated discourse transcript data 113, the feature-annotated discourse transcript data 113 may be passed to the TEE 106. The TEE 106 may process the feature-annotated discourse transcript data 113 to evaluate the interaction between the agent and customer according to the attributes of one or more compendiums. In other words, the TEE 106 may use the feature-annotated discourse transcript data 113 to score (i.e., generate an appropriate answer to) one or more attributes (as dictated by a compendium). Ideally, these attributes and their associated scores are about aspects of human-interest in understanding the context of the interaction and various faucets of the agent's conduct and performance in that interaction.

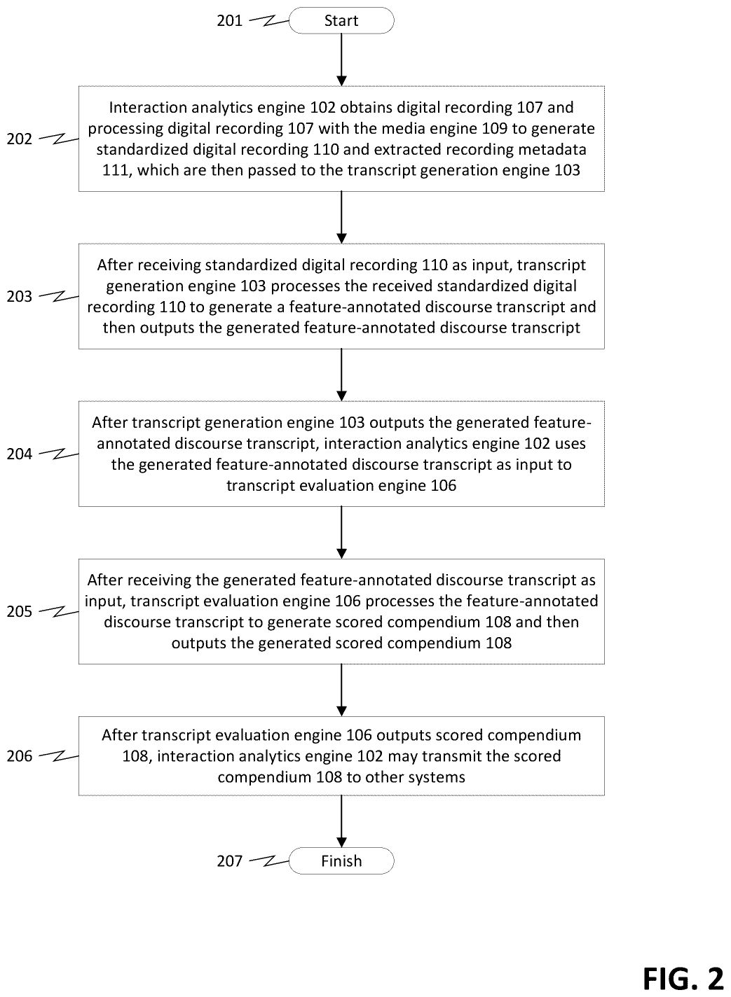

FIG. 2 is a flowchart illustrating a process of processing digital recording to generate scored compendium, as just described. To start, as shown by block 202 of FIG. 2, the IAE 102 may first obtain the digital recording 107 and process it with the media engine 109. The media engine 109 may convert the digital recording 107 into a standardized form, referred to as standardized digital recording 110. The media engine 109 may also extract certain file-level metadata from the digital recording 107 in the form of extracted recording metadata 111.

The digital recording 107 obtained by the AIE 102 may be a media file of various types, such as a text file (e.g., plain text (.txt), HTML (.html), JSON (.json), etc.), an audio file (e.g., MP3 File (.mp3), Microsoft Wave file (.wav), free lossless audio codec (.flac), etc.), or a video file (e.g., MPEG file (.mpg), WebM file (.webm), AVI files (.avi), etc.). In some embodiments, an audio file may contain multiple separate audio channels. For example, in some embodiments the digital recording 107 may comprise an audio file having two audio channels. One of the audio channels may comprise audio from a customer while the other audio channel comprises audio from an agent.

After the media engine 109 has processed the digital recording 107, the AIE 102 may initiate the process of generating a feature-annotated discourse transcript by providing the standardized digital recording 110 and the extracted recording metadata 111 as input to the transcript generation engine 103.

After the transcript generation engine 103 receives the standardized digital recording 110 as input, as shown by block 203 of FIG. 2, the transcript generation engine 103 may process the received standardized digital recording 110 to generate a feature-annotated discourse transcript. After the feature-annotated discourse transcript is generated, the transcript generation engine 103 may output the feature-annotated discourse transcript.

Broadly speaking, the TGE 103 processes the standardized digital recording 110 in two stages. In the first stage, referred to as the discourse extraction stage, the TGE 103 may work, through the discourse extraction engine 104, to create an initial transcript of the discourse between the agent and customer recorded by the standardized digital recording 110. This initial transcript may comprise the (text) transcription of the discourse between the agent and customer along with timing information (e.g., a timestamp) for each word or phrase.

In general, the details of how the discourse extraction engine 104 generates the initial transcript may depend on the nature of the standardized digital recording 110, particularly with regards to whether the recording has the dialogue in a text format directly accessible by a digital system (e.g., as from an email or instant messages) or is not in such a form (e.g., as from the audio from a phone call or video conference). For example, for digital recordings having an audio component (e.g., for digital recordings comprising an audio file or video file where the participants are verbally speaking), the discourse extraction engine 104 may use automatic speech recognition (ASR) to identify speech in the audio file and to determine the text transcription for any identified speech.

In the second stage of the transcript generation engine's processing of standardized digital recording 110, referred to as the feature extraction stage, the transcript generation engine 103 may determine various useful features of the interaction captured by the standardized digital recording 110. These useful features may then be used to generate a feature-annotated discourse transcript, where the annotations of the transcript indicate the determined features. As is discussed in more detail below, the steps described for the second stage of processing by the transcript generation engine 103 are performed by the transcript annotation engine 105.

At a high-level, this may involve processing the transcript produced by the first stage of processing to extract information from the indicated text. In addition, for digital recording comprising audio components (such as audio files and video files), the feature extraction stage may involve processing the audio component of the standardized digital recording 110 to infer information, from the raw audio, about various sections of text in the initial discourse transcript data. Once extracted, the information gleaned from analyzing the text of the initial discourse transcript data and the information gleaned from analyzing the raw audio of the standardized digital recording 110 may be both woven as text annotations into the text of the initial discourse transcript data to generate the feature-annotated transcript data.

Note that, in general, every word or utterance in the text transcript may be associated with a timestamp indicating (either in absolute terms or relative to the beginning of the standardized digital recording 110) when the word or utterance was made. In some embodiments, the timestamp may indicate the start of the word being spoken. In some embodiments, each word may be associated with two timestamps, one indicating the start of the word and the other indicating the end of the word. Additionally, every word or utterance in the text transcript may also be associated with a speaker (e.g., may be associated with either the agent or the customer). In some embodiments, the discourse extraction engine 104 may determine whether a word or other utterance is associated with the agent or with the customer by using a standardized digital recording 110 where the audio component has separate channels for the audio originating from the agent and the audio originating from the customer. In this example, if a given word or utterance originates from the agent's audio channel, the discourse extraction engine may determine that the word or utterance is associated with the agent and vice- versa.

After the transcript generation engine 103 outputs the feature-annotated discourse transcript, as shown by block 204 of FIG. 2, the interaction analytics engine 102 may use the feature-annotated discourse transcript as input to the transcript evaluation engine 106.

After receiving the feature-annotated discourse transcript as input, as shown by block 205 of FIG. 2, the transcript evaluation engine 106 may process the feature-annotated discourse transcript to generate scored compendium 108 and then provide it as output.

At a high-level, the transcript evaluation engine 106 may begin the process of generating the scored compendium 108 by determining one or more compendiums to assess the feature-annotated discourse transcript against. The transcript evaluation engine 106 may then analyze the feature-annotated discourse transcript generated by the transcript generation engine 103 to determine what attributes in a selected compendium are relevant to the interaction captured by the feature-annotated discourse transcript. For those attributes that the transcript evaluation engine 103 determines are relevant, the transcript may then, for each relevant attribute, use a corresponding attribute assessment model to the attribute's value (e.g., the answer to the attribute) by analyze the feature-annotated discourse transcript.

Note that the nature of the assessed value for an attribute—along with the nature of the collection of possible values for an attribute—may vary from attribute to attribute. For example, some attributes may use a consistency-based scoring method, where only two possible values may be used as the score of an attribute. These two values—which may be referred to as “yes” and “no,” or similar naming schemes—may assess only whether the behavior or aspect captured by the attribute is present, without assessing the quality of the behavior.

In contrast, some attributes may use a proficiency-based scoring method, where there are three (or more) possible values may be used as the score of an attribute. These three values—which may be referred to as “meets expectations,” “needs improvement,” and “unacceptable,” or similar naming schemes—may assess both whether the behavior or aspect captured is present (e.g., “meets expectations” or “unacceptable”) along with the quality of the behavior (e.g., “needs improvement”). Notably, “need improvement” may be the score for an assessment where expectations are not fully met but the agent's performance is nevertheless better than “unacceptable.” For example, the agent's performance may indicate a situation where the agent performed in a somewhat acceptable manner, but the performance is nevertheless deficient in some way such that better performance is possible (e.g., with additional training or behavior modification).

Additionally, in some embodiments, the proficiency-based scoring method may also include an option—which may be referred to as “not applicable,” “N/A,” or similar naming schemes—that indicates a given attribute is not relevant to the circumstances of the interaction being evaluated.

Other scoring methods may also be used for various attributes. For example, some attributes “score” may be a free-form text. As an example, one possible attribute is “the name of the customer.” In some embodiments, this attribute's “score” may be the text representation of the customer's name.

After the transcript evaluation engine 106 outputs the scored compendium 108, as shown by block 205 of FIG. 2, the interaction analytics engine 102 may transmit the scored compendium 108 to other systems. For example, the interaction analytics engine 102 may transmit the scored compendium 108 to an analytics engine. The analytics engine may use the scored compendium 108 to display the scores for the evaluated attributes in various formats. The analytics engine may also use the scored compendium 108 obtained for multiple interactions to conduct statistical analysis or perform data aggregation, the results of which the analytics engine may also display.

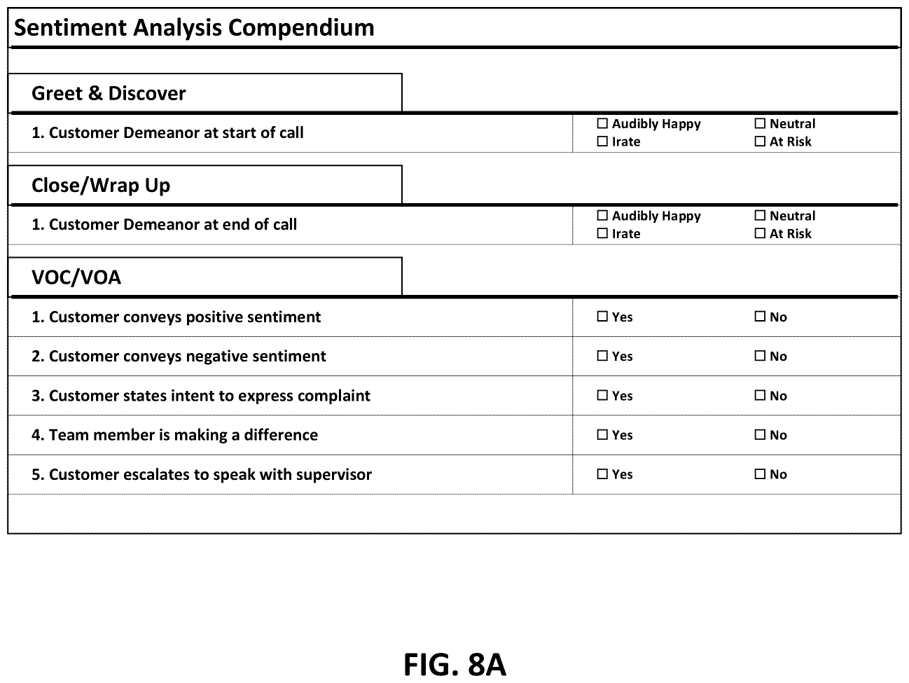

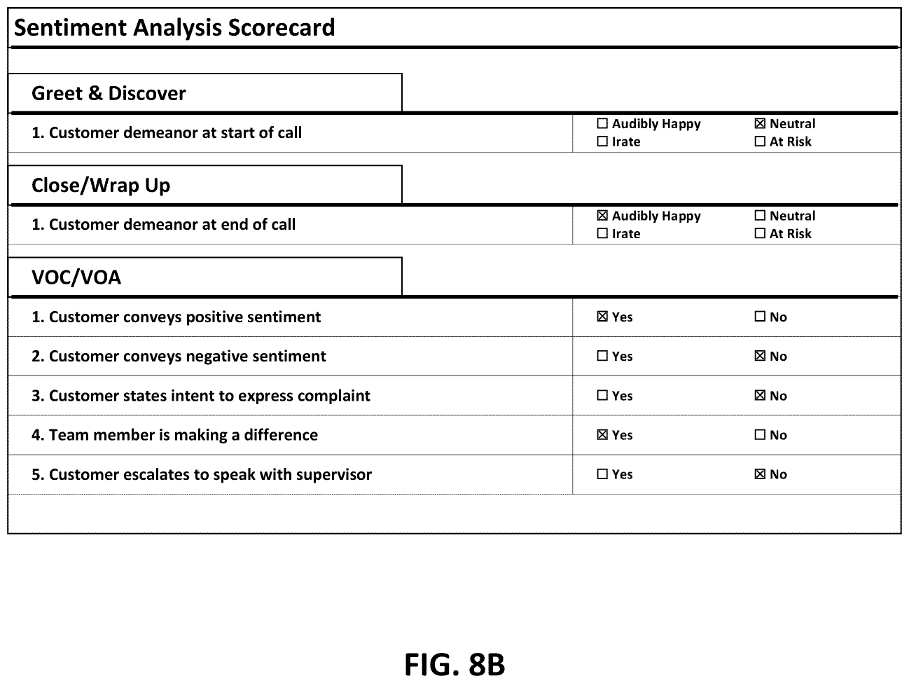

FIG. 8A is a diagram of an exemplary compendium, according to an exemplary embodiment of the present disclosure. As shown by the figure, a compendium may be composed of multiple attributes. For legibility purposes, these attributes may be grouped together into various categories or topics. As also shown by the figure, each attribute may be associated with a potential scoring method.

FIG. 8B is a diagram of a scored compendium based on the compendium of FIG. 8A. As shown by the figure, a scored compendium may be composed of scores for each of several attributes. These attributes may be reproduced along with the associated scores for ease of understanding.

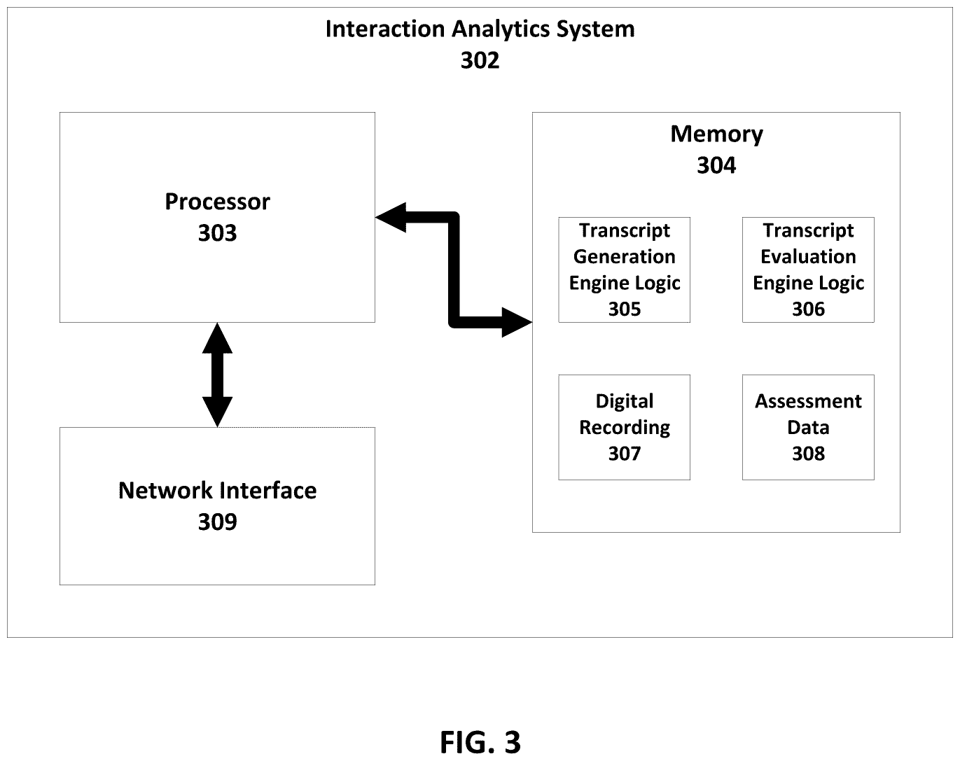

FIG. 3 is a block diagram of an interaction analytics system implementing an interaction analytics engine (e.g., the interaction analytics engine 102 of FIG. 1), according to an exemplary embodiment of the present disclosure. As shown by the figure, an interaction analytics system (IAS) 302 may comprise may comprise a processor 303, a memory 304, and a network interface 309. In general, the processor 303 may interact with and orchestrate the functioning of the various components of the IAS 302. In particular, the processor 303 may interact with the memory 304 to store and retrieve data, including instructions executable by the processor to achieve various functionality. The processor 303 may also interact with the network interface 309 to transmit and receive data, which may be used for various purposes.

At a high level, the IAS 302 may work to implement the interaction analytics engine 102. For the IAS 302 of FIG. 3, this may comprise storing in the memory 304 logic comprising logic on how to process a digital recording in the manner described for the IAE 102. As shown in the figure, this stored logic may comprise transcript generation engine logic 305 and transcript evaluation engine logic 306. As suggested by its name, the transcript generation engine logic 305 may comprise instructions that collectively implement the process described above for the transcript generation engine 103. Likewise, the transcript evaluation engine logic 306 may comprise instructions that collectively implement the process described above for the transcript generation engine 103.

The processor 303 may also—such as by following the instructions of control logic (not shown)—interact with the network interface 309 to obtain the digital recording 307 that is to be processed and to send the scored compendium 308 resulting from the assessment of the digital recording 307 to other systems or devices. As part of this process, both the digital recording 308 and the scored compendium 308 by be stored and retrieved from the memory 304.

In operation, the IAS 302 may first obtain a digital file storing a recorded interaction and store the digital file in the memory 304 as digital recording 307. More precisely, the processor 303 may interact with the network interface 309 to obtain a digital file containing a recorded interaction between an agent and a customer. The processor 303 may store obtained digital file in the memory 304 as digital recording 307. After the processor 303 has obtained the digital recording 307, the processor 303 may retrieve from memory 304 the transcript generation engine logic 305. The processor 303 may then process the digital recording 307 according to the instructions defined by the transcript generation engine logic 305 to obtain a feature-annotated transcript of the discourse in the interaction recorded by the digital recording 307. After generating the feature-annotated discourse transcript, the processor 303 may retrieve from memory 304 the transcript evaluation engine logic 306. The processor 303 may then process the feature-annotated discourse transcript according to the instructions defined by the transcript evaluation engine logic 306 to obtain the scored compendium 308.

Note that, while the interaction analytics system shown in FIG. 3 (i.e., the IAS 302) shows the transcript generation engine logic 305 and the transcript evaluation engine logic 306 being executed on the same device (specifically, executed by the same processor 303), in some embodiments the transcript generation engine logic 305 and the transcript evaluation engine logic 306 may be performed on different systems or executed by different processors.

Also note that, while the interaction analytics system shown in FIG. 3 (i.e., the IAS 302) shows the entirely of the transcript generation engine logic 305 and the transcript evaluation engine logic 306 being executed by one device, in some embodiments multiple devices may be involved in executing the transcript generation engine logic 305 or in executing the transcript evaluation engine logic 306. For instance, in some embodiments the functionality of the transcript generation engine logic 305 and the transcript evaluation engine logic 306 may be separated into smaller sets of instructions. These smaller sets of instructions may perform specific sub-tasks performed by the transcript generation engine logic 305 or the transcript evaluation engine logic 306. In some embodiments, these sub-tasks may be performed on different systems. As an example, in some embodiments the transcript generation engine logic 305 may comprise a discourse extraction engine logic (implementing the functionality of the discourse extraction engine 104) and a transcript annotation engine logic (implementing the functionality of the transcript annotation engine 105). In some embodiments, one system may execute the instructions of the discourse extraction engine logic while another system executes the instructions of the transcript annotation engine logic.

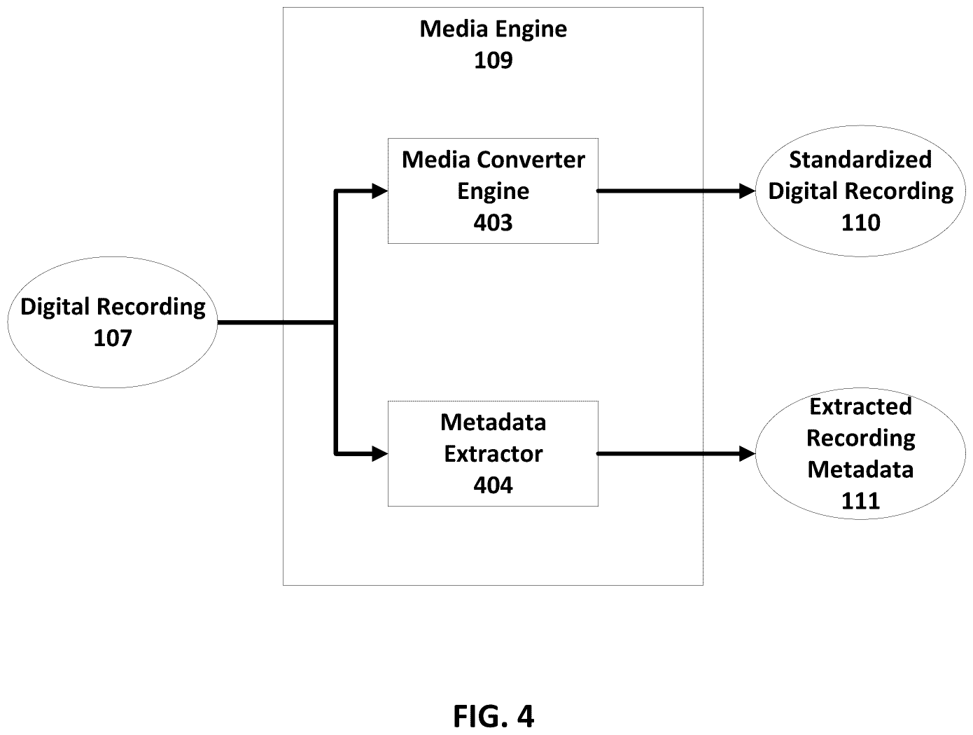

FIG. 4 is a more detailed block diagram of the media engine 109. As shown by the figure, the media engine 109 comprises a media converter engine 403 and a metadata extractor 404. The media converter engine 403 may act to process the standardized digital recording 110 and convert it into an equivalent but standardized version—standardized digital recording 405—for use in later sub-systems of the IAE 102 (e.g., transcript generation engine 103). The metadata extractor 404 may act to extract useful metadata contained within the digital file that comprises the standardized digital recording 110.

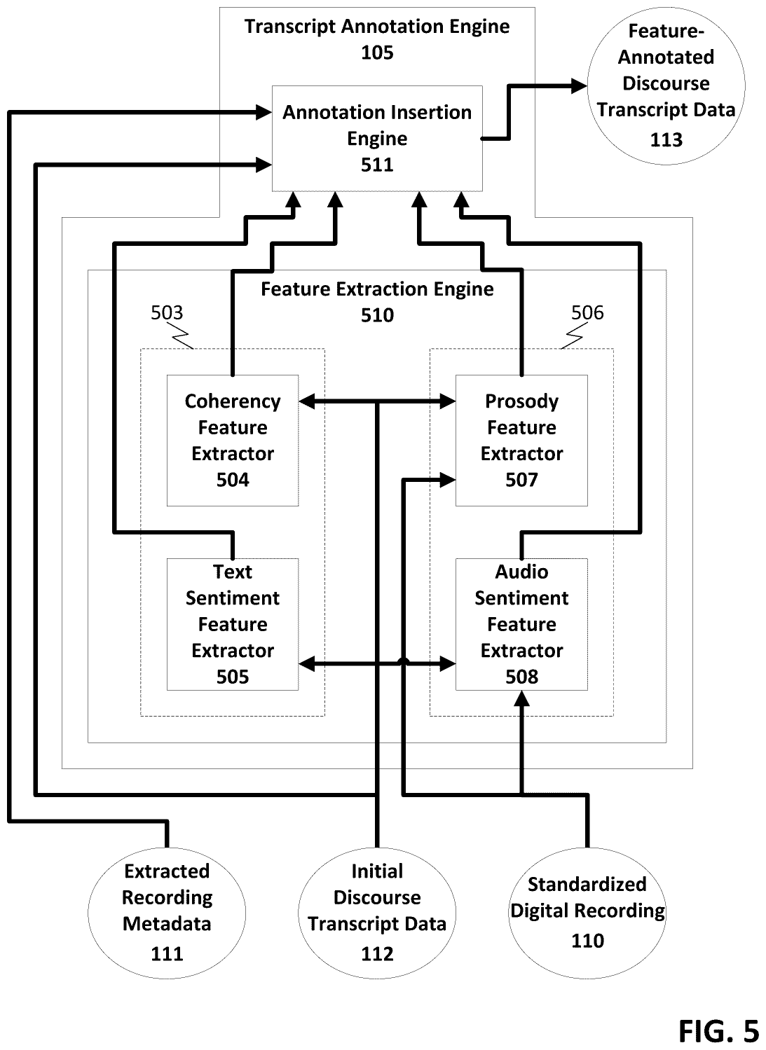

FIG. 5 is a more detailed block diagram of the transcript annotation engine 105. As shown by the figure, the transcript annotation engine 105 comprises a feature extraction engine 510 and an annotation insertion engine 511. At a high level, one purpose of the transcript annotation engine 105 may be to pre-emptively extract information that may later be used by the transcript evaluation engine 106 in generating the scored compendium 108. Ideally, this extracted information—along with the basic transcript—is sufficient to allow the transcript evaluation engine 106 to accurately score any relevant attributes. Towards this end, the feature extraction engine 510 may analyze the initial discourse transcript data 112 and the standardized digital recordings 110 to detect various features (i.e., specific information) of interest. For each detected feature, the feature extraction engine 510 may generate a tag identifying the type of feature along with information about the detected feature. The annotation insertion engine 511 may receive any of these tags of extracted features and insert them into the initial discourse transcript data to generate the feature-annotated discourse transcript data 113.

Towards this end, the feature extraction engine 510 may employ various sub-systems to search specific data sources—e.g., to search text or to search audio—or to look for certain families of features—e.g., to search for sentiment information. For example, in some embodiments, like is shown in the figure, the feature extraction engine 510 may comprise a text feature extraction engine 503—which may be used to analyze and extract features from text, such as the text of the initial discourse transcript data 112—and an audio feature extraction engine 506—which may be used to analyze and extract features from audio, such as the audio of the standardized digital recording 110. In turn, the text feature extraction engine 503 may comprise a coherency feature extractor 504—which may be used to extract and tag coherency features—and a text sentiment feature extractor 505—which may be used to extract and tag sentiment features. Similarly, the audio feature extraction engine 506 may comprise a prosody feature extractor 507—which may be used to extract and tag prosody features—and an audio sentiment feature extractor 508—which may be used to extract and tag sentiment features.

One example of a useful feature that may be extracted—here, by the coherency feature extractor 504—is instances where there is “overspeak”, particularly overspeak caused by the agent. Overspeak is when two or more persons speak simultaneously or, in colloquial term, “talk over” one another. In the context of the interaction between the customer service agent and the customer, overspeak refers to when both speak simultaneously. This may occur when, following momentary silence, both attempt to being speaking, an effect exacerbated by audio delays. Overspeak may also occur when either the agent or the customer are already talking and the other party beings to speak. Overspeak is a useful feature to extract because of what it may indicate about the conversation and overall interaction. Broadly speaking, overspeak is considered rude, especially overspeak of the second type. If initiated by an agent, overspeak may increase a customer's dissatisfaction with the interaction and cause a corresponding decrease in their opinion of the representative's organization.

One method that may be used by the coherency feature extractor 504 to detect overspeak is to analyze the initial discourse transcript data 112 to determine when (i.e., what periods of time) the agent was speaking and to similarly determine when the customer was speaking. Such periods may be identified based on the delay between words being spoken by the agent. For example, if the delay between the timestamp associated with a word and the timestamp associated with the next word is below a predefined threshold, then it may be determined that the two words are part of the same phrase being uttered and that agent is continuously speaking. On the other hand, a determination may be made that the agent has stopped speaking when the delay between word and the next words is greater than a predefined threshold.

After determining time periods when the agent is continuously speaking and when the customer is continuously speaking, the coherency feature extractor 504 may compare the periods of speech of the agent with the periods of speech of the customer to determine if any periods of speech from the agent overlaps with periods of speech of the customer. The coherency feature extractor 504 may generate a tag to mark any such periods of overlap as detected overspeak. For example, in some embodiments the coherency feature extractor may generate a tag comprising data indicating the tag is for an instance of overspeak, indicating a timestamp for when the overspeak began, and indicating a duration that the overspeak lasted. The tag data may also indicate additional information, such as a timestamp for when the overspeak ended and which speaker “caused” the overspeak (i.e., who began speaking while another was already speaking).

For embodiments employing timestamps marking both the start and end of a word or utterance, other methods may be used by the coherency feature extractor 504 to detect overspeak. As an example, the coherency feature extractor 504 may analyze the initial discourse transcript data 112 to determine, for each word or utterance, a period of time associated with that word or utterance. The coherency feature extractor 504 may then compare the periods of time for text tagged as being from the agent with periods of time for text tagged as being from the customer. The coherency feature extractor 504 may mark any instances where the periods associated with text tagged as being from the agent overlap the periods associated with text tagged as being from the customer as detected overspeak.

Another useful feature that may be extracted-here, by the text feature extraction engine 503—is instances where there is “hesitation” in the speech of the agent or customer. As used here, hesitation refers to situations where there is an unusually long pause (e.g., period of silence) in the dialogue between the agent and the customer. Instances where the unusually long pause is from the end of an utterance from one individual and the start of an utterance by the same individual may be called “speaker hesitation.” In contrast, instances where the unusually long pause is from the end of an utterance from one individual and the start of an utterance by a different individual may be called “dialogue hesitation.” These two types of hesitation may indicate different information.

For example, an occurrence where an agent says something, is silent for 5 seconds, and the resumes speaking—an instance of speaker hesitation—may indicate a lack of proficiency or confidence by the agent for tasks with which the agent should be familiar and comfortable. Speaker hesitation by a customer may indicate that the customer is confused or unhappy about an issue being discussed. In contrast, an occurrence where a customer says something, is silent for 5 seconds, and then the agent says something—an instance of dialogue hesitation—may indicate a lack of responsiveness by the agent. Note that these are broad hypothetical examples of what hesitation could, in specific cases, indicate. In particular, these examples are relatively simplistic and the full transcript evaluation engine 106 may utilize tagged instances of hesitation to make much more nuanced determinations.

One method that may be used by the feature extraction engine 503 to detect hesitation is to analyze the initial discourse transcript data 112 to determine when there were gaps in the conversation between the agent and customer (e.g., periods where neither the agent or the customer were speaking). For example, the text feature extraction engine 503 may detect an instance of speaker hesitation when the duration between the end of a phrase of one participant (e.g., agent or customer) and the beginning of a phrase by the same participant exceeds a predefined threshold. Likewise, the text feature extraction engine 503 may detect an instance of dialogue hesitation when the duration between the end of a phrase of one participant (e.g., agent or customer) and the beginning of a phrase by the other participant exceeds a predefined threshold.

For example, the timestamps associated with each word spoken by one of the participants may be compared to the timestamp of the immediately following word spoken (by any participant) to determine the delay between them. If this comparison indicates the delay exceeded a pre-defined threshold, the coherency feature extractor 504 may generate a tag to mark any such periods as detected hesitation. In particular, if the words defining the start and end of the detected delay are from the same speaker, the coherency feature extractor 504 may generate a tag to mark the period as specifically being detected speaker hesitation. In contrast, if the words defining the start and end of the detected delay are from different speakers, the coherency feature extractor 504 may generate a tag to mark the period as specifically being detected dialogue hesitation.

In some embodiments, the generated tag may comprise data indicating the tag is for hesitation (or a specific type of hesitation), indicating a timestamp for when the hesitation began, and indicating a duration the hesitation lasted. The tag data may also indicate additional information, such as a timestamp for when the hesitation ended.

One example of a useful feature that may be extracted by the audio sentiment feature extractor 508 is whether an agent or customer is speaking in a happy or otherwise positive fashion. This may be a useful feature to extract with respect to the agent because happy sounding speech tends to increase customer satisfaction, whereas unhappy or otherwise negative sounding speech tends to decrease customer satisfaction. On the other hand, this feature may be useful to extract with respect to the customer because it may indicate the customer's satisfaction with the interaction, either in general or with regards to certain parts of the interaction.

In some embodiments, the feature-annotated discourse transcript data 113 may be structured as a JSON file format, but other formats are possible in other embodiments.

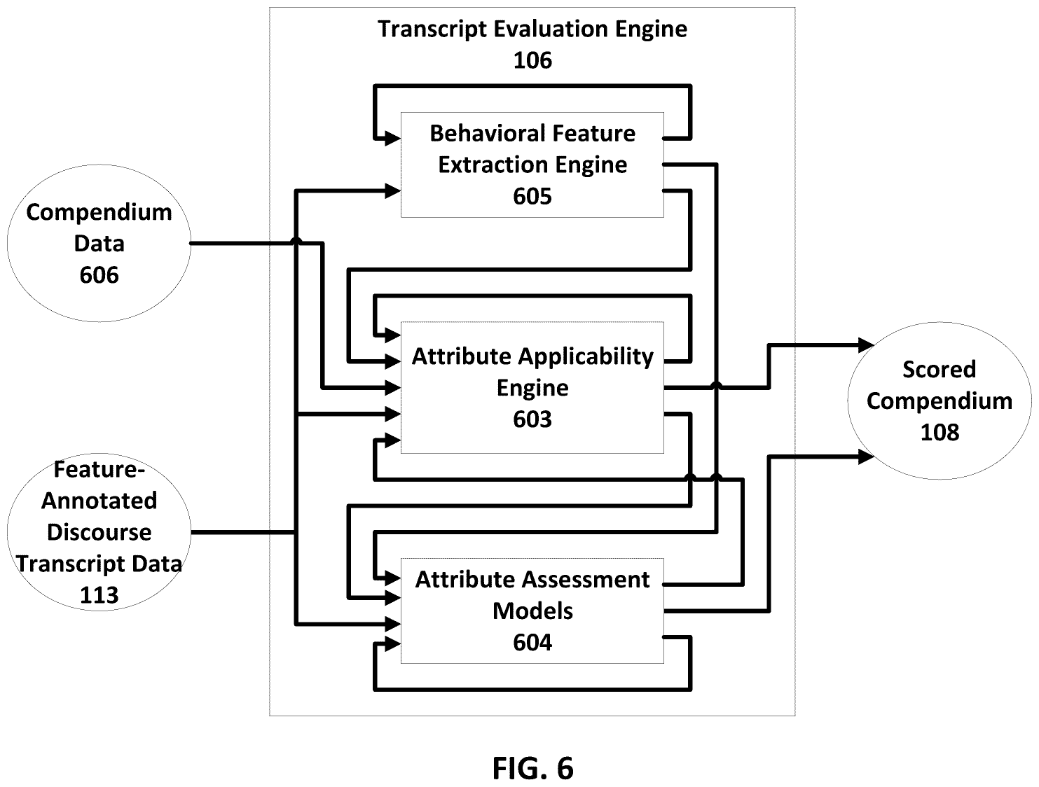

FIG. 6 is a more detailed block diagram of the transcript evaluation engine 106. As shown by the figure, the transcript evaluation engine 106 comprises a behavioral feature extraction engine 605, an attribute applicability engine 603, and attribute assessment models 604. At a high-level, the transcript evaluation engine 106 may work to assess the interaction (i.e., the interaction initially captured by the digital recording 107) with respect to one or more attributes. To achieve this, the transcript evaluation engine 106 may receive compendium data 606 indicating one or more collections of attributes (in the form of one or more compendiums) that the interaction may be assessed against. For each attribute indicated by the compendium data 606 that the transcript evaluation engine 106 determines should be scored for the current interaction, the transcript engine 106 may utilize a corresponding attribute assessment model to process the feature-annotated discourse transcript data 113 and output a score for the associated attribute. As part of this process, the transcript evaluation engine 106 may also utilize the feature-annotated discourse transcript data 113 to generate various higher-order features that may be relevant to various attributes (and that may be used by the attribute assessment models associated with these various attribute assessment models in scoring their associated attribute).

Notably, each of these three-processes may be iterative and mutually-interacting in that the output of one process may be used as input to the same process or as input to the other processes, where, in either case, it may influence their subsequent output.

To better explain, note that, conceptually, not every attribute in a compendium may be relevant to a given interaction and, in particular, the relevance of some attributes may depend on either the relevance of some other attribute or a certain score for some other attribute. Thus, the process of evaluating the interaction with the transcript evaluation engine 106 may begin by using the attribute applicability engine 603 to determine one or more attributes that are relevant (and thus should be assessed) for the current interaction. To achieve this, the attribute applicability engine 603 may first receive compendium data 606, which specifies one or more compendiums (each comprises of one or more potentially applicable attributes) to assess the current interaction against. The attribute applicability engine 603 may then receive and process the feature-annotated discourse transcript data 113 to ascertain one or more attributes from the identified compendiums that are relevant to the current interaction.

In general, each attribute is associated with an attribute assessment model that is configured to generate a score for the associated attribute using (among other information) the feature-annotated discourse transcript data 113. Thus, for each attribute ascertained by the attribute applicability engine 603, the corresponding attribute assessment model 604 may be used to generate a score for that attribute using the feature-annotated discourse transcript data 113. In other words, the corresponding attribute assessment model 604 may evaluate the interaction with respect to the associated attribute by scoring the interaction on the attribute. The resulting score for this attribute may then form part of the scored compendium 108.

Note that the output of an attribute assessment model—the resulting score for its associated attribute—may be sent to the attribute applicability engine 603 and used by the attribute applicability engine 603 to determine that one or more not-yet-selected attributes from the identified compendiums are relevant to the current interaction. Additionally, the attribute applicability engine 603 may also use its own determinations that one or more attributes are relevant in determining that other, not-yet-selected attributes are relevant. Together, these two interactions are referred to as one attribute (i.e., in being selected as relevant or as being evaluated to have a certain score) “triggering” another attribute.

In addition to the activity of the attribute applicability engine 603 and the attribute assessment models 604, the transcript evaluation engine 106 may also utilize the behavioral feature extraction engine 605 to determine certain higher-order features useful to the attribute applicability engine 603 in assessing the relevance of one or more attributes or useful to one or more attribute assessment models 604 in generating a score for their respective attributes. To determine these various higher-order features, the behavioral feature extraction engine 605 may process the feature-annotated discourse transcript data 113. For example, the behavioral feature extraction engine 605 may count the number of times that overspeak occurs in the conversation or during a certain time period of the conversation. A greater count may indicate that the agent is speaking over the customer more often, which may be a factor in the overall performance of the agent.

As an example of how the transcript evaluation engine 106 may create a scored compendium using the feature-annotated discourse transcript data 113, in some embodiments, one of the features included in the feature-annotated discourse transcript data 113 may be the presence of overspeak (possibly along with additional details about the overspeak), like was previously described. Furthermore, one (or more) of the attributes that the transcript evaluation engine 106 may evaluate relate to overspeak, such as was there overspeak, how severe (e.g., on average) was there overspeak, what was the average duration or number of occurrences of overspeak, and similar aspects. To evaluate these attributes, the transcript evaluation engine 106 may use the attribute applicability engine 603 to determine what attributes relevant to overspeak should be assessed. For example, if the attribute applicability engine 603 determines that there was no overspeak, only the attribute referring to the existence of overspeak may be assessed (e.g., with a value such as “no” or “false”), since there is no examples of overspeak to further assess.

On the other hand, if the attribute applicability engine 603 determines that there are one or more instances of overspeak, it may assess the attribute for the existence of overspeak (e.g., with a value such as “yes” or “true”) and may further determine that additional attributes relating to details about the overspeak should be assessed. For example, depending on the compendium and its associated attributes, the attribute applicability engine 603 may determine that attributes relating to the average overspeak severity, average overspeak duration, longest overspeak duration, and the like. After the attribute applicability engine 603 determines that these attributes are relevant and should be assessed, the transcript evaluation engine 106 may use the selected attributes to select corresponding attribute assessment models 604 and use those assessment models to generate an answer for their respective attributes.

To better illustrate the foregoing, assume that a first attribute indicated by the scored compendium 108 is whether overspeak occurred and, if overspeak occurred, a second attribute defines a score indicating an extent to which overspeak occurred. If any instance of overspeak is detected, the transcript evaluation engine 106 may control the scored compendium 108 to indicate that overspeak occurred. In such event, the engine 106 may further evaluate the detected overspeak conditions to generate a score and report the score as the second attribute of the scored compendium 108. As an example, the score may be higher for a greater number of overspeak instances and/or for longer durations of overspeak conditions, indicating that overspeak occurred to a greater extent during the conversation.

In another example, the attribute may not be specific to overspeak, but overspeak may be used as a factor to assess a broader attribute. For example, an assessed attribute may be how well the agent effectively communicated with a customer. If overspeak occurred to a relatively high extent, then the score of the effective communication assessment may be lowered due to the overspeak assessment. However, the score may be raised for other factors (e.g., the assessed tone of the agent) for which the agent performed well.

In some embodiments, one or more of the attribute assessment models 604 may comprise machine learning systems, such as artificial neural networks (ANNs). Such ANNs may be configured to receive as input the feature-annotated discourse transcript data 113 and, where relevant, higher-order features determined by the behavioral feature extraction engine 605. The ANNs may be trained to process this information to generate a score for a particular attribute.

One way that the scored compendium may be used is in coaching an agent to improve their performance. This coaching may be by identifying areas of weakness in an agent's performance so that the agent can change their behavior. The coaching may also be done by identifying areas of strength in an agent's performance to reinforce this behavior in future interactions.

To improve the ability and efficiency of a coach in evaluating an agent's performance and in coaching the agent to improve his or her performance, the interaction analytics engine 102 may provide features useful to the coaching process. For example, one feature that the interaction analytics engine 102 may provide is detecting instances where the agent's performance was in some way meritorious (i.e., was noteworthy in some aspect). Another feature that the interaction analytics engine 102 may provide is detecting instances where the agent's performance was in some way deficient, referred to herein as a “defect.” The interaction analytics engine 102 may determine a time interval when the defect occurred and may display, on a graphical interface, the presence or an indication of the defect. The graphical interface may display a short description of the defect and may indicate on a graphical display of the timeline of the call where the defect occurred. The graphical interface may also allow the defect to be selected and readily played back to allow better discussion and critique of the agent's performance.

One way that the interaction analytics engine 102 may determine whether there is a defect is by using the evaluated attributes in the scored compendiums 108 derived from digital recordings 107 of the agent's performance and/or other information determined by the transcript evaluation engine 106. The interaction analytics engine 102 may also utilize various features extracted by the transcript annotation engine 105 (e.g., by using the feature-annotated discourse transcript data 113).

As an example, assume that overspeak is related to a particular attribute, such as the effectiveness at which the agent communicates with the customer. Further, assume that an overspeak condition that persists for at least a threshold amount of time is deemed as a defect related to communication effectiveness. In the course of evaluating the feature-annotated discourse transcript data 113, the transcript evaluation engine 106 may be configured to detect and mark in the data 113 occurrences of defects (e.g., overspeak conditions having a duration greater than the foregoing threshold). Such marking may include the approximate time of the defect within the conversation as well as the type of defect detected. As an example, a particular defect for an overspeak condition may be indicated as an overspeak defect and/or a defect related to communication effectiveness (or some other attribute). Thus, the feature annotated discourse transcript data 113 may be later analyzed to determine various metrics about the agent's performance, such as the agent's defect rate (e.g., number of detects per call or per unit of time) for certain types of defects.

In some embodiments, the system is configured to present information to a user in a user-friendly manner in order to assist the user in finding certain types of defects in calls that can be used as coaching opportunities to help train the agent to improve call performance. As an example, assume that the feature-annotated discourse transcript data 113 stored over time for many calls for a given agent indicates that the agent has performed poorly in a certain assessed attribute, such as call effectiveness. The system allows a user, referred to hereafter as “coach” for simplicity of illustration, to submit inputs to search for coaching opportunities related to a certain defect in the calls associated with the agent. As an example, if the agent has performed poorly in call effectiveness, the coach may provide an input to search for calls having instances of defects related to call effectiveness or to particular aspects of call effectiveness, such as overspeak.

In response, the system may generate a list of calls for which the transcript evaluation engine 106 found and marked defects related to the defect type input by the coach. Such list may be sorted based on various factors, such as the number or rate of defects of interest. The coach may select one of the calls of the list and use the selected call for training, as will be described in more detail below.

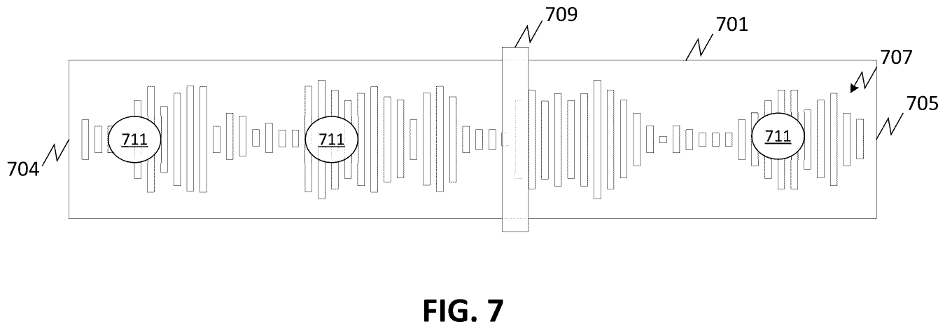

In this regard, when the coach or other user selects a call from the list, a graphical user interface (GUI) having a timeline 701 depicted by FIG. 7 may be displayed. In addition, the standardized digital recording 110 and the feature-annotated discourse transcript data 113 associated with the selected call are retrieved. The horizontal axis of the timeline 701 depicted by FIG. 7 represents the time of the call with the leftmost point 704 on the timeline 701 being the start of the call, and the rightmost point 705 on the timeline 701 being the end of the call. Included within the timeline 701 is a row of vertical lines 707 where each vertical line 707 represents a sample period in the call. The height of each vertical line 707 may indicate a measured parameter associated with the time period, such as the average power of the audio signal for the sample period. Each line may be color coded to indicate which participant was predominantly speaking during the sample period or whether there was silence (i.e., absence of dialogue) during the sample period.

As shown by FIG. 7, the timeline 701 has a vertical marker 709 indicating the point on the timeline 701 for which the standardized digital recording 110 is playing. That is, as the standardized digital recording 110 plays allowing the users to listen to the conversation, the marker 709 advances from left to right such that the marker 709 is at the location on the timeline 701 corresponding to the conversation being played, as is known in the art for playing digital recordings of audio files.

Within the timeline 701, detected defects are marked with indicators 711, which are shown as circles in FIG. 7, but other types of indicators and shapes may be used in other embodiments. Thus, a user may view the timeline 701 to see at what points in the call defects were detected. If the user wishes to hear the conversation at the point of a defect, the user may select the defect of interest, at which point the marker 709 is moved to the selected indicator 711 and the recorded conversation is played from that point. The playback of the conversation where the defect occurred may be an opportunity for the agent to learn from past defects in order to improve his or her call performance.

As an example, assume that the agent has a low score for call effectiveness due to various defects, such as instances of overspeak. The coach, while engaged in a coaching session with the agent, may search for calls associated with defects related to call effectiveness, select one of the listed calls, and then click on one of the indicators 711 at which point the system begins audibly playing the call at the time of the defect. Thus, the agent and the coach can hear the playback of the defect, and the coach can provide instruction on how to better handle the call to try to avoid the defect in the future. In this example, defects detected by the transcript evaluation logic 106 can be quickly found and utilized to help coach the agent.

In some embodiments, the system may be configured to present information to the user to assist and guide the user in improving their performance. For example, in some embodiments, the system may present information to the user indicating to the user areas where their performance is below some threshold. For instance, in some embodiments the system may present information to the user indicating to the user their performance relative to other agents along certain metrics (e.g., along certain attributes). In particular, the system may highlight to the user metrics where there performance is lower than the average performance of other agents. Here, “lower” may mean in absolute terms or may mean lower by some threshold amount. Additionally, the “other agents” may mean the other agents of the contact center generally or may mean some sub-group of these agents.

To determine a user's average performance for various metrics, the system may assess a plurality of interactions by the user with a customer to generate a plurality of scored compendiums. The system may store the scored compendiums and use them to calculate, for each desired metric, an average score for the user. The system may also do this for multiple users in a contact center and may further average, for each desired metric, the average score of multiple users to determine the relative performance of the contact center's agents for that metric.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The devices, modules, and other functional units described in this disclosure can be implemented by hardware, or software, or a combination of hardware and software. One of ordinary skill in the art will also understand that the above described devices, modules, and other functions units may be combined or may be further divided into a plurality of sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

Now, therefore, the following is claimed:

1. A method for assessing an interaction, comprising:
obtaining a digital recording of an interaction between a customer service representative and a customer, wherein the digital recording comprises at least an audio component;
processing, by the processor, the digital recording to generate feature-annotated discourse transcript information comprising inferred features of the interaction between the customer service representative and the customer; and
processing, by the processor, the feature-annotated discourse transcript information to generate scored compendium information comprising evaluations of the interaction between the customer service representative and the customer with respect to a plurality of attributes of a compendium;
determining, by the processor, one or more defects within the digital recording based on the generated scored compendium information; and
automatically generating a graphical user interface comprising a visual indication for each of the one or more defects based on the determination.

2. The method of claim 1, wherein the inferred features of the generated feature- annotated discourse transcript information comprises:
an initial discourse transcript component that is representative of a first application program executable by the processor containing text data corresponding to a written representation of the speech between the customer service representative and the customer; and
an annotation component that is representative of a second application program executable by the processor containing information about a plurality of features of sections of the text data contained in the initial discourse transcript component.

3. The method of claim 2, wherein processing the digital recording to generate the feature-annotated discourse transcript information comprises:
generating the text data contained in the initial discourse transcript component by evaluating the audio component of the digital recording;
generating feature data representing inferred information about a plurality of features of sections of the text data contained in the initial discourse transcript component; and
annotating the generated initial discourse transcript component with the generated feature data.

4. The method of claim 1, wherein processing the feature-annotated discourse transcript information to generate the scored compendium information comprises:
extracting behavioral feature data using the feature-annotated discourse transcript information and already extracted behavioral feature data;
determining one or more applicable attributes of the compendium using the feature-annotated discourse transcript information, the extracted behavioral feature data, and already determined applicable attributes; and
generating an assessment for each of the determined one or more applicable attributes using a corresponding attribute assessment model to process the feature-annotated discourse transcript information, the extracted behavioral feature data, and already generated applicable attribute assessments.

5. The method of claim 2, wherein the generated feature-annotated discourse transcript information further comprises timestamps indicating for the text data of the initial discourse transcript component when the corresponding speech between the customer service representative and the customer occurred.

6. The method of claim 3, wherein evaluating the audio component of the digital recording to generate initial discourse transcript data corresponding to the written representation of the speech between the customer service representative and the customer comprises using automatic speech recognition to process the audio component of the digital recording.

7. The method of claim 1, wherein the digital recording comprises a digital media file, wherein the digital media file comprises content capturing the interaction between the representative and the customer.

8. The method of claim 4, wherein at least one of the corresponding attribute assessment models comprises an artificial neural network.

9. A system for assessing an interaction, comprising:
a network interface that is representative of a first application program executable by the system and configured to obtain a digital recording of an interaction between a customer service representative and a customer, wherein the digital recording comprises at least an audio component;
a transcript generation engine that is representative of a second application program executable by the system and configured to generate feature-annotated discourse transcript information by processing the obtained digital recording, wherein the feature-annotated discourse transcript information comprises inferred features of the interaction between the customer service representative and the customer; and
a transcript evaluation engine that is representative of a third application program executable by the system and configured to generate scored compendium information by processing the feature-annotated discourse transcript information, wherein the scored compendium information comprises evaluations of the interaction between the customer service representative and the customer with respect to a plurality of attributes of a compendium;
wherein the system is further configured to:
determine, by the processor, one or more defects within the digital recording based on the generated scored compendium information; and
automatically generate a graphical user interface comprising a visual indication for each of the one or more defects based on the determination.

10. The system of claim 9, wherein the inferred features of the generated feature- annotated discourse transcript information comprises:
an initial discourse transcript component that is representative of a fourth application program executable by the system and containing text data corresponding to a written representation of the speech between the customer service representative and the customer; and
an annotation component that is representative of a fifth application program executable by the system and containing information about a plurality of features of sections of the text data contained in the initial discourse transcript component.

11. The system of claim 10, wherein the second application program representing the transcript generation engine system comprises:
a discourse extraction engine configured to generate the text data contained in the initial discourse transcript component by evaluating the audio component of the digital recording; and
a feature extraction engine configured to:
generate feature data representing inferred information about a plurality of features of sections of the text data contained in the initial discourse transcript component; and
annotate the generated initial discourse transcript component with the generated feature data.

12. The system of claim 9, wherein the third application program representing the transcript evaluation engine comprises:
a behavioral feature extraction engine configured to extract behavioral feature data using the feature-annotated discourse transcript information and already extracted behavioral feature data;
an attribute applicability engine configured to determine one or more applicable attributes of the compendium using the feature-annotated discourse transcript information, the extracted behavioral feature data, and already determined applicable attributes; and
one or more attribute assessment models, wherein:
each of the one or more attribute assessment models corresponds to one of the one or more determined applicable attributes; and
the one or more attribute assessment models are configured to generate an assessment for their corresponding attribute by processing the feature-annotated discourse transcript information, the extracted behavioral feature data, and already generated applicable attribute assessments.

13. The system of claim 10, wherein the generated feature-annotated discourse transcript information further comprises timestamps indicating for the text data of the initial discourse transcript component when the corresponding speech between the customer service representative and the customer occurred.

14. The system of claim 11, wherein at least one of the corresponding attribute assessment models comprises an artificial neural network.

15. A non-transitory computer readable medium comprising instructions that, when executed by one or more processors, cause the one or more processors to assess an interaction by:
obtaining a digital recording of an interaction between a customer service representative and a customer, wherein the digital recording comprises at least an audio component;
processing the digital recording to generate feature-annotated discourse transcript information comprising inferred features of the interaction between the customer service representative and the customer; and
processing the feature-annotated discourse transcript information to generate scored compendium information comprising evaluations of the interaction between the customer service representative and the customer with respect to a plurality of attributes of a compendium;
determining, by the processor, one or more defects within the digital recording based on the generated scored compendium information; and
automatically generating a graphical user interface comprising a visual indication for each of the one or more defects based on the determination.

16. The non-transitory computer readable medium of claim 15, wherein the inferred features of the generated feature-annotated discourse transcript information comprises:
an initial discourse transcript component that is representative of a first application program executable by the processor containing text data corresponding to a written representation of the speech between the customer service representative and the customer; and
an annotation component that is representative of a second application program executable by the processor containing information about a plurality of features of sections of the text data contained in the initial discourse transcript component.

17. The non-transitory computer readable medium of claim 16, wherein processing the digital recording to generate the feature-annotated discourse transcript information comprises:
generating the text data contained in the initial discourse transcript component by evaluating the audio component of the digital recording;
generating feature data representing inferred information about a plurality of features of sections of the text data contained in the initial discourse transcript component; and
annotating the generated initial discourse transcript component with the generated feature data.

18. The non-transitory computer readable medium of claim 15, wherein processing the feature-annotated discourse transcript information to generate the scored compendium information comprises:
extracting behavioral feature data using the feature-annotated discourse transcript information and already extracted behavioral feature data;
determining one or more applicable attributes of the compendium using the feature-annotated discourse transcript information, the extracted behavioral feature data, and already determined applicable attributes; and
generating an assessment for each of the determined one or more applicable attributes using a corresponding attribute assessment model to process the feature-annotated discourse transcript information, the extracted behavioral feature data, and already generated applicable attribute assessments.

19. The non-transitory computer readable medium of claim 16, wherein the generated feature-annotated discourse transcript information further comprises timestamps indicating for the text data of the initial discourse transcript component when the corresponding speech between the customer service representative and the customer occurred.

20. The non-transitory computer readable medium of claim 18, wherein at least one of the corresponding attribute assessment models comprises an artificial neural network.
